(19) United States
(12) Patent Application Publication
(10) Pub. No.: US 2010/0055031 A1
(43) Pub. Date: Mar. 4, 2010

(54) ICE NANORODS FOR HYDROGEN STORAGE

(76) Inventor: Dong June Ahn, Seoul (KR)

Correspondence Address: EDWARDS ANGELL PALMER & DODGE LLP, P.O. BOX 55874, BOSTON, MA, 02205, US

(21) Appl. No.: 12/200,470

(22) Filed: Aug. 28, 2008

(51) Int. Cl. C01B 3/50; B32B 1/00

(52) U.S. Cl. 423/658.2; 428/401

(57) ABSTRACT

The compositions and methods disclosed herein relate to ice nanorods having an elongate shape and a diameter in a range from 1 nm to 1000 nm. The ice nanorods include hydrogen hydrates that releasably store hydrogen. The hydrogen hydrates can be formed from ice and hydrogen under suitable conditions of high pressure and/or low temperatures. The ice nanorods allow the rapid formation of hydrogen hydrates and/or release of hydrogen due to the shape of the ice nanorods. The elongate shape and small diameter of the ice nanorods results in a high surface area of ice that allows rapid diffusion of a hydrogen gas into and out of the ice, thereby allowing rapid formation of hydrogen hydrates and release of hydrogen during use.

### BACKGROUND

Hydrogen has long been regarded as a promising source of fuel, both as a replacement for conventional hydrocarbon fuels and as a fuel for alternative energy technologies, such as fuel cells. The lightest element, hydrogen has a very high energy-to-weight ratio, and can be combusted cleanly, without carbon monoxide or dioxide byproducts. For the use of hydrogen to be a feasible fuel source, the hydrogen needs to be stored.

A common technique for storing large quantities of hydrogen is a liquefaction process by compressing and cooling hydrogen from a gas phase into a liquid phase. At ambient pressure, hydrogen gas liquefies at 20 K (i.e., −253° C.), and approximately 70 g/L of the hydrogen gas can be stored in the liquid phase. However, the liquefaction process is very energy intensive. For example, the energy used to compress hydrogen gas into a liquid may be as much as 40% of the energy that is within the gas itself. In other words, an additional amount of energy equivalent to about 40% of the energy capable of being expended from the hydrogen gas is needed to liquefy the hydrogen. In addition, liquid hydrogen needs to be maintained at 20 K to prevent the liquefied hydrogen gas from boiling off.

Another common technique for storing hydrogen is to compress the gas into a suitable vessel. For example, a gas tank pressurized to 35 MPa can store 15 g/L of hydrogen. However, a pressurized-gas tank is heavy and cumbersome. In addition, the circumstances for the transport and use need to be carefully controlled.

Yet another technique for storing hydrogen involves chemically bonding hydrogen molecules to a host material such as a metal or carbon nanotube. Hydrogen storage in metal hydrides and carbon nanotubes is difficult because of the high temperatures needed to release the hydrogen from the material. Despite the many attempts to store hydrogen, hydrogen storage mechanism remains a key challenge for practical usage of hydrogen as a general fuel.

### BRIEF SUMMARY

The compositions and methods disclosed herein relate to ice nanorods having an elongate shape and a diameter in a range from 1 nm to 1000 nm. The ice nanorods include hydrogen hydrates that releasably store hydrogen. The hydrogen hydrates can be formed from ice and hydrogen under suitable conditions of high pressure and/or low temperatures. The ice nanorods allow the rapid formation of hydrogen hydrates and/or release of hydrogen due to the shape of the ice nanorods. The elongate shape and small diameter of the ice nanorods results in a high surface area of ice that allows rapid diffusion of hydrogen gas into and out of the ice, thereby allowing rapid formation of hydrogen hydrates and release of hydrogen during use.

In one embodiment, the ice nanorods are a bundle of ice nanorods. The bundles of ice nanorods provide a relatively compact material while maintaining the high surface area and excellent diffusion of the individual ice nanorods. The bundles of ice nanorods therefore provide for high density storage of hydrogen. The individual ice nanorods can have a diameter in a range from about 1 nm to 1000 nm, alternatively, about 2 nm to about 500 nm, about 5 nm to about 100 nm, or about 8 nm to about 50 nm. The nanorods can have any length, so long as the length is greater than the diameter. Examples of suitable lengths include, but are not limited to about 2 nm to about 1 mm, about 5 nm to about 0.5 mm, or about 20 nm to about 1000 nm.

The hydrogen hydrates formed in the ice nanorods are solid compounds with “guest” hydrogen molecules trapped in an H₂O framework. The hydrogen hydrates are typically formed at low temperature while at either a high or ambient pressure. In one type of hydrogen hydrate, water molecules form hydrogen-bonded “cages” around “guest” hydrogen molecules to form a clathrate. Examples of suitable clathrates include, but are not limited to, hydrogen bonded to water in which the cage structure is either sI, sII, or sH type. In other hydrogen hydrates, the “guest” hydrogen molecules fill in structural cavities of specific phases of ice.

In some embodiments, the hydrogen hydrate is a clathrate with two or more sizes of cages. The different sized cages can provide improved stability to the clathrate structure, thereby improving the formation of the hydrate and its release.

Although not required, in some embodiments, the ice nanorod composition includes the ice hydrates supported on a substrate. Typically the substrate facilitates the formation of ice nanorods in an elongate shape and having a diameter in a range from 1 nm to 1000 nm. Examples of suitable substrates for the ice nanorods include, but are not limited to, carbon nanofibers and ceramic nanofibers. Examples of carbon nanofibers include, but are not limited to, carbon nanotubes. Examples of ceramic nanofibers include, but are not limited to, silica nanofibers and alumina nanofibers.

The methods for making ice nanorods include the acts of forming water and hydrogen into ice nanorods, where the ice nanorods have an elongate shape and a diameter in a range from 1 nm to 1000 nm. In one embodiment, a nanorod-shaped ice is formed first and then a hydrogen hydrate is formed by exposing the ice to hydrogen under suitable conditions to form a hydrogen hydrate. In an alternative embodiment, a mixture of water and hydrogen are formed into an ice nanorod that includes hydrogen hydrates.

The methods of forming the ice nanorods can include the use of a promoter compound to reduce the pressure needed to form the hydrogen hydrate and/or to increase the hydrogen storage capacity of the hydrogen hydrates. The promoter compound can be an organic compound with less than 20 carbon atoms, alternatively less than 10 carbon atoms. One type of suitable organic compound that can be used as a promoter is a cyclic organic compound having an oxygen atom, pendant or incorporated in the ring. Examples of cyclic organic promoters that can be used in manufacturing the ice nanorods include, but are not limited to cyclobutanone, tetrahydrofurane, tetrahydropyrane, or derivaties thereof (e.g., tetrahydrofuranol, tetrahydrofurfuryl alcohol and the like). In one embodiment, the promoter is included in the ice hydrogen hydrates in a concentration in a range from about 0.15 mol % to about 3.0 mol %, alternatively in a range from about 0.15 mol % to about 1.0 mol %.

In one embodiment, the ice nanorods can be manufactured using a catalyst to promote nucleation and/or formation of hydrogen hydrates. Examples of catalysts include, but are not limited to, inorganic compounds such as, but not limited to, salts and phosphates (e.g., NaCl, CaCl₂), or light organic compounds (e.g., less than 200 MW) such as, but not limited to, methanol, ethanol, acetone, and urea.

These and other features of the ice nanorods will become more fully apparent from the following description, drawings, and appended claims, or may be learned by the practice of the claims as set forth hereinafter. The foregoing summary is illustrative only and is not intended to be in any way limiting.

### BRIEF DESCRIPTION OF THE DRAWINGS

FIG. 1 illustrates a bundle of ice nanorods; and

FIG. 2 is a pressure-temperature phase diagram of the H₂—H₂O system; and

FIG. 3 is a block diagram describing a method for making ice nanorods.

### DETAILED DESCRIPTION

The illustrative embodiments described in the detailed description, drawings, and claims are not meant to be limiting. Other embodiments may be utilized, and other changes may be made, without departing from the spirit or scope of the subject matter presented here.

### I. Ice Nanorods

The compositions and methods disclosed herein relate to ice nanorods having an elongate shape and a diameter in a range from 1 nm to 1000 nm. The individual ice nanorods can have a diameter in a range from about 1 nm to 1000 nm, alternatively, about 2 nm to about 500 nm, about 5 nm to about 100 nm, or about 8 nm to about 50 nm.

The nanorods can have any length, so long as the length is greater than the diameter. Examples of suitable lengths include, but are not limited to about 2 nm to about 1 mm, about 5 nm to about 0.5 mm, or about 20 nm to about 1000 nm.

The ice nanorods include hydrogen hydrates that releasably store hydrogen. The ice nanorods stably store hydrogen as a hydrogen hydrate in the ice. The elongate shape and small diameter of the ice nanorods results in a high surface area of ice that allows rapid diffusion of a hydrogen gas into and out of the ice, thereby allowing rapid formation of hydrogen hydrates and release of hydrogen during use.

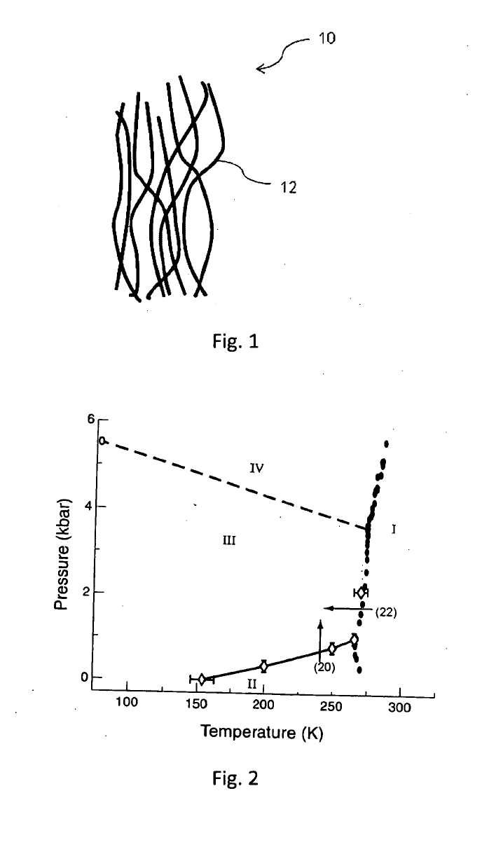

In one embodiment, the ice nanorods are a bundle of ice nanorods. FIG. 1 illustrates a bundle of ice nanorods 10 that include several individual ice nanorods (e.g. ice nanorod 12). The bundles of ice nanorods can include any number of individual ice nanorods 12. In one embodiment, the bundles of ice nanorods include between 10¹ to 10⁸ individual nanorods. The bundles of ice nanorods provide a compact, but porous material that allows hydrogen to diffuse relatively quickly compared to ground ice. The bundles of ice nanorods therefore provide for high density storage of hydrogen.

The hydrates are solid compounds with “guest” hydrogen molecules trapped in an H₂O framework. The hydrogen hydrates are typically formed at low temperature while at either a high or ambient pressure. In one type of hydrogen hydrate, water molecules form hydrogen-bonded “cages” around “guest” hydrogen molecules to form a clathrate. Examples of suitable clathrates include, but are not limited to, hydrogen bonded to water in which the cage structure is either sI, sII, or sH type. In other hydrogen hydrates, the “guest” hydrogen molecules fill in structural cavities of specific phases of ice. A general description of clathrates is disclosed in U.S. Patent Application Publication No. 2003/0089117 to Moa, which is hereby incorporated by reference.

Although not required, in some embodiments, the ice nanorod composition can include the ice hydrates supported on a substrate. Typically the substrate facilitates the formation of ice nanorods in an elongate shape and having a diameter in a range from about 1 nm to about 1000 nm, alternatively 2 nm to about 100 nm, or about 5 nm to about 50 nm.

Examples of suitable substrates for the ice nanorods include, but are not limited to, carbon nanofibers and ceramic nanofibers. Examples of carbon nanofibers include, but are not limited to, carbon nanotubes. Examples of ceramic nanofibers include, but are not limited to, silica nanofibers and alumina nanofibers.

As described below with regard to the methods of making ice nanorods, in some embodiments, the ice nanorods can include a promoter compound. The promoter compound can be an organic compound with less than 20 carbon atoms, alternatively less than 10 carbon atoms or between about 5 carbons and 10 carbons or between about 6 carbons and 8 carbons. One type of suitable organic compound that can be included in the ice nanorods are cyclic organic compounds having an oxygen atom, pendant or incorporated in the ring. The number of atoms in the ring can be about 5 carbons, or in a range from 5 carbons to 20 carbons or alternatively in a range from 5 atoms to 10 atoms.

Examples of cyclic organic promoters that can be included in the ice nanorods include but are not limited to cyclobutanone, tetrahydrofurane, tetrahydropyrane, or derivaties thereof (e.g., tetrahydrofuranol, tetrahydrofurfuryl alcohol and the like).

In one embodiment, the promoter is included in the ice hydrogen hydrates in a concentration in a range from about 0.15 mol % to about 3.0 mol %, alternatively in a range from about 0.15 mol % to about 1.0 mol %. Including the promoter within these ranges, in some embodiments, can maximize the amount of hydrogen that can be stored in the ice hydrates and/or minimize the pressure required to stably form and/or maintain the hydrogen hydrates in the ice nanorods.

### II. Methods for Manufacturing Ice Nanorods

The methods for making ice nanorods include the acts of forming water and hydrogen into ice nanorods, where the ice nanorods have an elongate shape and a diameter in a range from 1 nm to 1000 nm. In one embodiment, a nanorod-shaped ice is formed first and then a hydrogen hydrate is formed by exposing the ice to hydrogen under suitable conditions to form a hydrogen hydrate. In an alternative embodiment, a mixture of water and hydrogen are formed into an ice nanorod that includes hydrogen hydrates.

One method for forming ice nanorods includes providing a nanorod substrate and depositing ice and/or hydrogen hydrate on the nanorod substrate. The nanorod substrate can facilitate the formation of ice nanorods in an elongate shape and having a diameter in a range from 1 nm to 1000 nm.

A. Manufacturing Hydrates in Ice Nanorods

In one embodiment, the hydrogen hydrates are formed into ice nanorods prior to forming the hydrogen hydrates in the ice. In this method, ice can be in a phase I and thereafter formed into a clathrate by applying hydrogen pressure in a range from about 77 K to about 275 K above the equilibrium point. In this embodiment, the synthesis involves causing the ice to cross the phase boundary from Region II to Region III as shown in FIG. 2, represented by vertical arrow 20.

Referring to FIG. 2, a phase diagram of H₂O—H₂, solid circles represent the melting curve points and define a phase boundary between Region I and Regions II, III, and IV. Region I defines F(H₂) and F(H₂O/H H₂) phases corresponding to the fluid/gas H₂ and liquid/fluid hydrogen solution in water. Region II defines a hydrogen solution in an ice-I and F(H₂) phase, bounded by a low-pressure boundary line corresponding to the equilibrium of hydrogen clathrate with a solution of hydrogen in ice-I. This low-pressure boundary line is defined by the points represented by diamonds (⋄).

Region III is defined as the hydrogen clathrate stability field and comprises hydrogen clathrate-sII, which is a cubic structure II clathrate hydrate phase and F(H₂). The quadruple point, at about 265 K and 1.0 kbar, is defined at the intersection of the clathrate low-pressure boundary line with the melting curve, and denotes a point where the existing stable phases are clathrate-sII, hydrogen solution in ice-I phase, hydrogen solution in water, and fluid hydrogen.

Region IV is separated from Region III by a high-pressure boundary line (dotted line) that limits the upper end of the hydrogen clathrate stability field, separating the hydrogen clathrate-sII from a solution of hydrogen in ice-IV that together with F(H₂) comprises Region IV. Another quadruple point exists at about ˜274 K and ˜3.7 kbar, where the stable phases are clathrate-sII, solution of hydrogen in ice-IV phase, hydrogen solution in water, and fluid hydrogen.

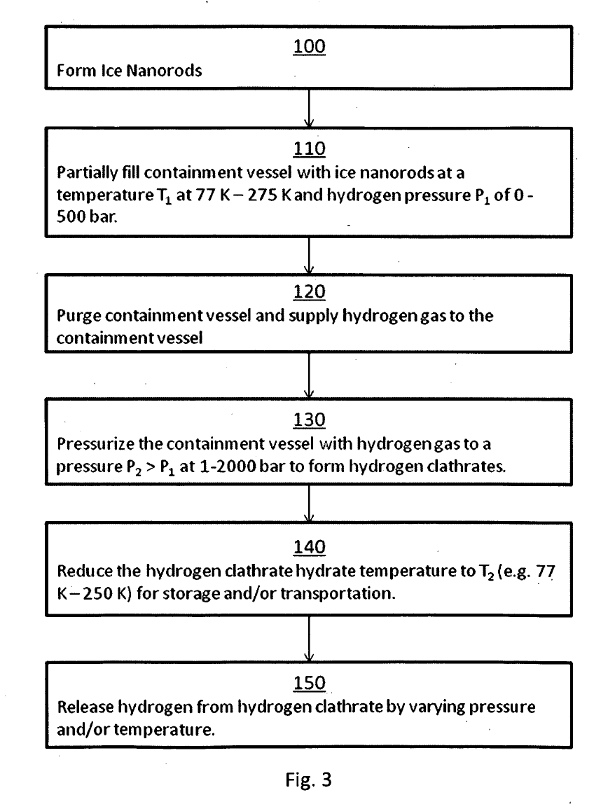

FIG. 3 is a flowchart displaying an illustrative method. In a first step 100, ice nanorods are formed. In one embodiment, the ice nanorods are formed by providing a nanofiber such as a carbon nanotube or a ceramic nanofiber. A small layer of ice is formed on the nanofibers by exposing the nanofibers to humid air at below freezing temperatures to allow ice to accumulate on the outside of the nanofiber. Alternatively water and the nanofiber can be mixed together and the nanofibers spun while being exposed to freezing temperatures to achieve an ice coating of a desired thickness.

Next, in step 110, a containment vessel is partially filled with the ice nanorods. The containment vessel can be initially at a temperature T₁ between about 77 K and about 275 K and hydrogen partial pressure P₁ between about 0 and about 500 bar (i.e., within Region II in FIG. 2). The containment is selected to be able to withstand the maximum projected hydrogen pressure and to support the supply and release of hydrogen gas. The vessel includes features that allow filling with ice and extracting ice or hydrogen clathrate. Cooling or heating devises may be located inside or outside the vessel to achieve the desired temperature and/or pressure controls. Additional features, such as pressure/temperature gauges and relief valve(s) may also be added.

The containment vessel is only partially filled to allow for volume expansion as the hydrogen clathrate hydrates are formed. By starting the process with ice nanorods, the formation of hydrogen clathrate hydrates occurs rapidly throughout the ice portion of the material, without liquid water, which is desirable since hydrogen is almost insoluble in water. Note that since ice-I has a lower density than water, volume penetration of hydrogen molecules into the ice-I body significantly accelerates clathrate formation.

At Step 120, the containment vessel may be purged with hydrogen, nitrogen, or other neutral gas to avoid combustible oxygen-hydrogen mixtures within the containment vessel. Then, hydrogen gas is supplied to the containment vessel, raising the pressure, while the temperature is maintained (an isothermal process). As the pressure rises above the equilibrium point (the solid line in FIG. 2, boundary between hydrogen clathrate and a solution of hydrogen in ice-I) the hydrogen clathrate hydrates begin to form.

At Step 130, the hydrogen pressure is raised to the desired pressure P₂ (where P₂>P₁), within the range of 1 to 2000 bar, belonging to the clathrate P-T stability field (Region III in FIG. 2). The time it takes to form the hydrogen clathrate hydrates at this new pressure is based on the size of the ice nanorods and distribution, pressure, temperature, and the catalyst used (if any). The use of ice nanorods has a substantial impact on the rate at which hydrogen is released at a given temperature and pressure, whether or not a catalyst is included.

Note that in steps 100, 120 and/or 130, a catalyst may be added to accelerate the nucleation and/or formation of hydrogen clathrate. Different type of catalysts known to those skilled in the art may be used for this purpose. Formation of clathrates near the ice melting point occurs faster than at lower temperatures. Thus, one type of catalyst is a compound, which exhibits low eutectic point with H₂O, or when in solution with water exhibits a lower melting point. Catalysts include, but are not limited to, inorganic compounds, like salts and phosphates (NaCl, CaCl₂, Ca(NO₃)₂, CaHPO₄, (NH₄).₃PO₄, etc.), and any light organic compounds (molecular weight less than 200), like methanol, ethanol, acetone, and urea.

At Step 140, the temperature within the containment vessel may be lowered to temperature T₂ within the range of 77 K and 250 K (T₂<T₁) to maintain the hydrogen clathrate hydrates at pressure P₃ (P₃<P₂), chosen within the range of clathrate P-T stability field between 1 bar and 500 bar (within Region III in FIG. 2). Reducing the pressure allows for the transportation and storage of clathrate hydrate (and, consequently hydrogen) in low pressure containers that reduces the risk and increases the safety of hydrogen storage operations.

It should be noted that variation of pressure and/or temperature in Step 140 may result in the change of the hydrogen percentage stored in the clathrate hydrate. Thus, adjustment of the composition of the clathrate for the optimal hydrogen occupancy can be made by variation of P-T condition at step 140. In particular, decrease of temperature results in the saturation of the hydrogen content in the clathrate.

Finally, at step 150, the hydrogen content in the hydrogen clathrate phase may be adjusted by varying either the pressure or temperature within the containment (or storage) vessel. As the content of hydrogen clathrate is reduced, hydrogen is released for use as a fuel or other purpose.

B. Forming Hydrogen Hydrates During Formation of Ice Nanorods

In an alternative embodiment, the ice is formed as a hydrogen hydrate contemporaneously with the formation of the ice nanorods. In this embodiment, hydrogen and water are placed in a container together under conditions suitable for forming a hydrogen hydrate. For example, a hydrogen hydrate can be formed on a nanofiber substrate.

In an illustrative embodiment, the ice nanorods can store about 50 g/L at moderate cryogenic temperatures of approximately 77 K to 250 K and at moderate to ambient pressures of 35 MPa to 10 kPa.

The method can be performed in any vessel suitable for controlling the pressure and temperature to within the desired ranges. In one embodiment, the method includes partially filling a vessel with water. For example, the vessel can be filled with an amount of water sufficient to fill about 20% to 70% of the volume of the vessel with water (e.g., de-ionized water or other relatively pure water that does not have impurities that negatively affect formation of the hydrate).

If desired, a pressure calibration material, such as ruby grains, can be added to the vessel with the water. The pressure calibration material does not react with either the water or a hydrogen gas, which is subsequently introduced into the containment vessel. The inclusion of a pressure calibration material allows independent verification of the pressure in the containment vessel by external instrumental methods, such as fluorescence spectroscopy through a window of a diamond anvil. The pressure calibration material can also be used in more conventional compression apparatus, such as a gas tank, if a window exists such that spectroscopy or other analytical methods can be performed.

In addition, a hydrogen gas is provided to the vessel with the water. The hydrogen gas is provided into the remaining volume of the containment vessel at a pressure of, for example, 200 MPa. Although the method is described with the water being added first to the vessel, an alternative is that the water can be added after the hydrogen gas is provided. However, if the water is provided after the hydrogen gas is provided to the vessel, the water typically needs to be provided to the vessel under a higher pressure than the pressure under which the hydrogen gas is provided.

After water and hydrogen gas are provided to the vessel, the pressure in the vessel is increased and the temperature of the vessel is decreased to form a hydrogen hydrate such as a hydrogen clathrate in which cages formed by the water molecules contain the hydrogen. In the case of a gas tank, the pressure can be increased by pumping an increased amount of hydrogen into the gas tank. In the case of a Mao-Bell cell, the upper and lower anvils together with the metal gasket are used to compress the containment vessel within the cell. In both cases, liquid nitrogen can be used for cooling by either immersion into liquid nitrogen or heat exchangers using a flow of liquid nitrogen. As the pressure on the hydrogen gas and water increases and the temperature decreases, the hydrogen clathrate is formed. A clathrate, also known as a clathrate hydrate, is a class of solids in which the guest molecules occupy, fully or partially, cages in the host structure made of hydrogen bonded water molecules.

Examples of clathrates include the archetypal sI, sII, or sH clathrate crystal structures. Typically, the clathrate includes at least two different cage structures. Depending on the pressure and temperature conditions during the formation process, some residual water and/or hydrogen may be residual in the vessel. After the hydrogen hydrate has formed, instrumental techniques such as Raman spectroscopy, x-ray diffraction, and fluorescence spectroscopy may be used to verify the phases present. The pressure and temperature can be held at designated values, such as 100 to 600 MPa and 77 K, for a period of several hours to allow the hydrogen hydrate to stabilize, for example, as a hydrogen clathrate.

After any desired “hold” period is complete, the hydrogen hydrate is quenched. For example, in the case where the hydrogen hydrate is a hydrogen clathrate, the hydrogen clathrate can be quenched isobarically to a moderate cryogenic temperature in the range of 77 K to 250 K. The term “moderate cryogenic temperature” is meant to encompass any cryogenic temperature above 77 K that can be maintained by the application of liquid nitrogen or other types of refrigerant liquids.

In addition or in the alternative, the hydrogen hydrate can be quenched isothermally to a moderate pressure or ambient pressure. For example, pressures from about 35 MPa to an ambient pressure of about 0.01 MPa are moderate pressures. Although the methods include isobarically quenching the hydrogen hydrate to a moderate cryogenic temperature and then isothermally quenching the hydrogen hydrate to a moderate pressure, the hydrogen hydrate can first be isothermally quenched to a moderate pressure and then isobarically quenched to a moderate cryogenic temperature.

The hydrogen hydrate can be maintained at the moderate cryogenic temperature and/or moderate to ambient pressure for as long as desired to effect storage of hydrogen. Because the hydrogen hydrate, such as a hydrogen clathrate, is stable at moderate cryogenic temperature and ambient pressure, the hydrogen hydrate can be utilized as a source of fuel, for example, in an automotive fuel cell. The stored hydrogen gas is released by warming the hydrogen hydrate to a temperature higher than about 140 K at which temperature the hydrogen hydrate decomposes to release hydrogen. Alternatively, a controlled release can be affected by a process of gradual warming between 100 and 150 K that causes hydrogen gas to be released at a constant rate. For example, a hydrogen hydrate as disclosed herein can store hydrogen up to 25 K at a pressure of 35 MPa. The stored hydrogen gas can be released rapidly due to the elongate shape of the ice nanorods, thereby leading to relatively high partial pressures of hydrogen from the hydrogen hydrates during decomposition.

The methods, as described above, involve the formation of a hydrogen hydrate at a relatively high pressure and low temperature. However, it is possible to form and stabilize a hydrogen hydrate at low temperatures, without the use of high pressures. In this embodiment, the step of partially filling the containment vessel with water can include providing a pressure calibration material, such as ruby grains, to the containment volume in addition to the water.

In the alternative, a seed material can be added to the containment volume after the step of providing hydrogen gas to the containment volume. For example, a small amount less than 5% by vessel of a “seed” material could be added to the hydrogen mix such that the hydrogen hydrate will form at low temperature in a temperature range of 77 K to 250 K and near-ambient pressure, such as 10-100 kPa.

Seed materials can include any water-based clathrates, such as a methane hydrate, ethane hydrate or a previously formed hydrogen hydrate that has a clathrate structure. The structure of the seed material should be substantially similar to a clathrate structure such that a clathrate will form when the temperature of the hydrogen mix is reduced. The seed material not only facilitates the formation of a hydrogen hydrate, such as a hydrogen clathrate, but also aids in stabilizing the hydrogen hydrate at moderate cryogenic temperatures.

After the seed material and hydrogen gas are provided, the temperature of the vessel is decreased to form a hydrogen clathrate. The hydrogen clathrate is maintained at the moderate cryogenic temperature and/or moderate to ambient pressure for as long as desired to effect storage of hydrogen. Because the hydrogen clathrate is formed and stabilized with the seed material, the hydrogen clathrate can be utilized as a source of fuel, for example, in an automotive fuel cell at ambient pressure and a moderate cryogenic temperature.

C. Manufacturing Ice Nanorods Using a Promoter

When a promoter compound is incorporated into the composition, a clathrate hydrate can be formed at a temperature and/or a pressure, which is much closer to ambient temperature and ambient pressure than when such a compound is not present. A decrease in the pressure needed to obtain a clathrate hydrate of at least 80% is possible. The cryogenic temperatures that are required without the presence of a promoter compound, are not required if a promoter compound is present. A clathrate hydrate will then be obtained even at ambient temperature or higher.

In one embodiment, the promoter is an organic compound. Substituted organic compounds were shown to be suitable organic promoter compounds, including, but not limited to, cyclic organic compounds. The cyclic organic compounds can include atoms other than carbon, pendant or incorporated in the ring. Furthermore, a cyclic organic compound having an oxygen atom, pendant or incorporated in the ring, is useful. Examples of promoter compounds that are useful include, but are not limited to, cyclobutanone, tetrahydrofurane, tetrahydropyrane or derivatives thereof, such as tetrahydrofuranol, tetrahydrofurfuryl alcohol and the like.

Totally or partially halogenated organic compounds are also useful as promoter compounds. These organic compounds typically do not contain more than ten carbon atoms, and often include less than four carbon atoms. An example of such a compound is trifluoromethane. Other halogenides that can be used include, but are not limited to compounds with bromide, chloride, and/or iodide.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An ice nanorod composition for storing hydrogen, comprising:
ice nanorods having an elongate shape and a diameter in a range from 1 nm to 1000 nm, wherein the ice nanorods include hydrogen hydrates.

2. An ice nanorod composition as in claim 1, wherein the ice nanorods are a bundle of nanorods.

3. An ice nanorod composition as in claim 1, wherein the hydrogen hydrates are supported on carbon nanofibers, ceramic nanofibers, or a combination thereof.

4. An ice nanorod composition as in claim 1, wherein the hydrogen hydrates are supported on carbon nanotubes.

5. An ice nanorod composition as in claim 1, wherein the hydrogen hydrates are supported on a silica nanorod.

6. An ice nanorod composition as in claim 1, wherein the hydrogen hydrates are hydrogen clathrate hydrates.

7. An ice nanorod composition as in claim 6, wherein the hydrogen clathrate hydrates include at least two different-sized cages.

8. An ice nanorod composition as in claim 7, further comprising tetrahydrofuran (THF).

9. An ice nanorod composition as in claim 8, wherein the THF concentration is in a range from about 0.15 mol % to about 3.0 mol %.

10. An ice nanorod composition as in claim 8, wherein the THF concentration is in a range from about 0.15 mol % to about 1 mol %.

11. An ice nanorod composition as in claim 1, wherein the ice nanorod is under a pressure of 1 bar to 2000 bar.

12. An ice nanorod composition as in claim 1, wherein the ice nanorod is under a pressure of about 50 bar to about 200 bar.

13. An ice nanorod composition as in claim 1, wherein the diameter of the nanorods is in a range from 2 nm to 100 nm.

14. An ice nanorod composition as in claim 1, wherein the diameter of the nanorods is in a range from 5 nm to 50 nm.

15. A method for making an ice nanorod composition for storing hydrogen, comprising:
forming water into ice nanorods, the ice nanorods having an elongate shape and a diameter in a range from about 1 nm to about 1000 nm; and
exposing the ice nanorods to hydrogen under conditions suitable for forming hydrogen hydrates in the ice nanorods.

16. A method form making ice an ice nanorod composition as in claim 15, wherein the nanorods are a bundle of nanorods.

17. An ice nanorod composition as in claim 15, wherein the ice nanorod is formed by freezing water on a carbon nanofiber, a ceramic nanofiber, or a combination thereof.

18. An ice nanorod composition as in claim 15, wherein the ice nanorod is formed by freezing water on a carbon nanotube.

19. An ice nanorod composition as in claim 15, wherein the ice nanorod is formed by freezing water on a silica nanorod.

20. A method of using an ice nanorod composition, comprising:
(i) providing ice nanorods;
(ii) storing hydrogen in the ice nanorods by exposing the ice nanorods to hydrogen under conditions suitable for forming hydrogen hydrates to form hydrogen hydrates in the ice nanorods; and
(iii) removing stored hydrogen from the ice nanorods by exposing the ice hydrates to a temperature and pressure suitable for releasing the hydrogen from the hydrogen hydrates in the ice nanorods.
